(19) United States
(12) Patent Application Publication
(10) Pub. No.: US 2013/0049535 A1
(43) Pub. Date: Feb. 28, 2013

(54) ULTRASONIC SENSOR

(71) Applicants: Boum Seock Kim, Gyunggi-do (KR); Jung Min Park, Gyunggi-do (KR); Eun Tae Park, Gyunggi-do (KR)

(72) Inventors: Boum Seock Kim, Gyunggi-do (KR); Jung Min Park, Gyunggi-do (KR); Eun Tae Park, Gyunggi-do (KR)

(73) Assignee: SAMSUNG ELECTRO-MECHANICS CO., LTD., Gyunggi-do (KR)

(21) Appl. No.: 13/340,049

(22) Filed: Dec. 29, 2011

(30) Foreign Application Priority Data
Aug. 22, 2011 (KR) 1020110083608

(51) Int. Cl. G01H 11/08

(52) U.S. Cl. 310/322

(57) ABSTRACT

Disclosed herein is an ultrasonic sensor including: a cylindrical case; a piezoelectric element disposed on a bottom surface of an inner portion of the case; first and second terminals to which each of positive and negative voltages is applied from the outside; a connection member including a conductive member having a first area to which the first terminal is connected and a second area to which the second terminal is connected and a support member adhered to a lower surface of the conductive member; and a temperature compensation element penetrating between the first and second areas of the conductive member and being then inserted into the support member.

### CROSS REFERENCE TO RELATED APPLICATION

This application claims the benefit of Korean Patent Application No. 10-2011-0083608, filed on Aug. 22, 2011, entitled “Ultrasonic Sensor”, which is hereby incorporated by reference in its entirety into this application.

### BACKGROUND OF THE INVENTION

1. Technical Field

The present invention relates to an ultrasonic sensor.

2. Description of the Related Art

Recently, an ultrasonic sensor has been used to sense side and back areas in order to increase stability of a vehicle.

The ultrasonic sensor serves to measure a position of an object that is around the vehicle and a distance from the vehicle to the object and generate a warning sound or perform monitoring in order to prevent an accident of the vehicle or a person. For example, a device mounted in the back of the vehicle and generally called a “back sonar” is used in order to prevent collision between the vehicle and an object (a person) during a process of backing the vehicle in order to park the vehicle in a parking area.

This back sonar is used to detect an object including persons or other obstacles that is in the back area of the vehicle.

The ultrasonic sensor according to the prior art includes a piezoelectric element adhered to a bottom surface of an aluminum case by epoxy, or the like, a sound absorbing material disposed on an upper portion of the piezoelectric element and absorbing vibration energy of an ultrasonic wave to thereby reduce a reverberation time and protect embedded components, a printed circuit board (PCB) disposed on an upper portion of the sound absorbing material, a temperature compensation element mounted on the PCB and compensating for a change in sensitivity according to an external temperature, lead wires through which a voltage is applied from the outside, and electrodes for connection with the lead wire bonded to the piezoelectric element.

Since the ultrasonic sensor according to the prior art as described above requires several soldering processes in order to mount the temperature compensation element on the PCB and connect the lead wires to the respective electrodes of the PCB, a manufacturing process thereof is not easy, such that it is difficult to perform automation and mass production thereof

### SUMMARY OF THE INVENTION

The present invention has been made in an effort to provide an ultrasonic sensor that does not require a soldering process in assembling components disposed in the ultrasonic sensor and connecting lead wires, such that products may be easily manufactured.

According to a preferred embodiment of the present invention, there is provided an ultrasonic sensor including: a cylindrical case; a piezoelectric element disposed on a bottom surface of an inner portion of the case; first and second terminals to which each of positive and negative voltages is applied from the outside; a connection member including a conductive member having a first area to which the first terminal is connected and a second area to which the second terminal is connected and a support member adhered to a lower surface of the conductive member; and a temperature compensation element penetrating between the first and second areas of the conductive member and being then inserted into the support member.

The conductive member may be provided with a cutting part dividing the first and second areas, the support member may be provided with a groove corresponding to the cutting part, and the temperature compensation element may penetrate through the cutting part and be then inserted into the groove.

The temperature compensation element may penetrate through the conductive member so that each of a first surface having a positive electrode formed thereon and a second surface corresponding to the first surface and having a negative electrode formed thereon contacts the first and second areas.

The ultrasonic sensor may further include: a first lead wire having one end connected to the first terminal; and a second lead wire having one end connected to the second terminal, wherein each of the other ends of the first and second lead wires is inserted from upper surfaces of the first and second areas of the conductive member toward lower surfaces thereof and is then inserted into the support member.

The ultrasonic sensor may further include a third lead wire having one end connected to an electrode formed on an upper portion of the piezoelectric element, wherein the other end of the third lead wire penetrates through the support member and is then inserted from a lower surface of the first area of the conductive member toward an upper surface thereof.

The second area of the conductive member may have a ‘ [symbol] [symbol] ’ bent shape, wherein a ‘—’ portion of the ‘ [symbol] ’ shape is adhered to the support member and a ‘┐’ portion thereof contacts an inner sidewall of the case.

The conductive member may be made of a conductive rubber or a conductive film.

The ultrasonic sensor may further include comprising a sound absorbing material disposed on the piezoelectric element in the inner portion of the case and a molding material filled in the inner portion of the case.

The support member may be made of a non-conductive material, and the support member may have the same shape as that of the bottom surface of the inner portion of the case and have the same area as that of the bottom surface of the inner portion of the case.

The entire thickness of the connection member may be lower than a height of an inner wall of the case.

### BRIEF DESCRIPTION OF THE DRAWINGS

FIG. 1 is a cross-sectional view showing a structure of an ultrasonic sensor according to a preferred embodiment of the present invention;

FIG. 2 is a top perspective view showing a structure of a connection member into which a temperature compensation element and lead wires are inserted in a configuration of the ultrasonic sensor according to the preferred embodiment of the present invention; and

FIG. 3 is a bottom perspective view showing the structure of the connection member into which the temperature compensation element and the lead wires are inserted in the configuration of the ultrasonic sensor according to the preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from preferred embodiments and the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. In the description, the terms “first”, “second”, and so on are used to distinguish one element from another element, and the elements are not defined by the above terms.

Hereinafter, preferred embodiments of the present invention will be described in detail with reference to the accompanying drawings.

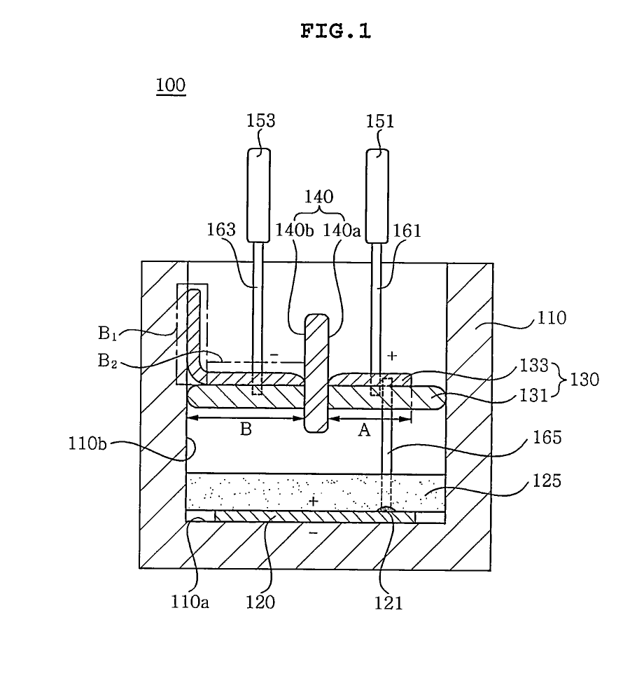

FIG. 1 is a cross-sectional view showing a structure of an ultrasonic sensor according to a preferred embodiment of the present invention.

Referring to FIG. 1, the ultrasonic sensor 100 according to the preferred embodiment of the present invention includes a cylindrical case 110, a piezoelectric element 120, a first terminal 151, a second terminal 153, a connection member 130, and a temperature compensation element 140.

The case 110 has a cylindrical shape including a bottom surface 110a and a sidewall 110b as shown in FIG. 1. A material of the case is not particularly limited. For example, the case may be made of an aluminum material and is preferably made of a material having low acoustic impedance, that is, a metal material that easily vibrates.

According to the present embodiment, the case 110 may be made by cutting machining but is not particularly limited thereto. For example, the case 110 may be manufactured by press molding or injection molding.

According to the present embodiment, the case 110 may include the piezoelectric element 120 adhered to the bottom surface 110a thereof.

The piezoelectric element 120 generates extension vibration or thickness vibration by forming electrodes (not shown) on both surfaces of a disk-shaped piezoelectric ceramic plate and applying a voltage between these electrodes. According to the present invention, an electrode (not shown) on one side (hereinafter, referred to as a ‘lower surface’) of the piezoelectric element is adhered to the bottom surface 110a of the case 110 by a conductive adhesive, or the like, and an electrode (not shown) on the other side (hereinafter, referred to as an ‘upper surface’) of the piezoelectric element 120 is bonded to one end of a third lead wire 165 that may be inserted into a connection member 130 to be described below.

Here, one end of the third lead wire 165 and the electrode formed on an upper surface of the piezoelectric element 120 may be bonded to each other by soldering 121.

According to the present embodiment, as shown in FIG. 1, a negative (−) electrode of the piezoelectric element 120 may be adhered to the bottom surface 110a of the case 110 so that a positive (+) electrode thereof is directed toward an inner side of the case 110, but is not limited thereto.

In addition, the piezoelectric element 120 may include a sound absorbing material 125 adhered to the upper surface thereof, wherein the sound absorbing material 125 is used to absorb an ultrasonic wave directed toward the inner side of the case 110.

The sound absorbing material 125 may be, for example, non-woven, felt, or the like, but is not particularly limited thereto, and may be adhered to the piezoelectric element 120 by an adhesive.

The ultrasonic sensor 100 according to the present embodiment may includes the first terminal 151 and the second terminal 153 to which each of a positive (+) voltage and a negative (−) voltage is applied from the outside.

In addition, the piezoelectric element 120 may further include a first lead wire 161 of which one end is connected to the first terminal 151 and a second lead wire 163 of which one end is connected to the second terminal 153.

According to the present embodiment, the connection member 130 may include a conductive member 133 and a support member 131 supporting the conductive member 133.

The conductive member 133 may be made of a conductive rubber, a conductive film, or the like but is not particularly limited thereto. For example, the conductive member may be made of any material having conductivity and flexibility.

According to the present invention, the conductive member 133 may be divided into a first area A connected to the first terminal 151 and a second area B connected to the second terminal 153, as shown in FIG. 1.

Here, the second area B of the conductive member 133 has a ‘ [symbol] [symbol] ’ bent shape, wherein a ‘—’ portion B₂ of the ‘ [symbol] ’ shape may be adhered to the support member 131 and a ‘┐’ portion B₁ thereof may contact the inner sidewall 110b of the case 110. Therefore, the second terminal 153 and the case 110 may be electrically connected to each other.

Here, when the conductive member 133 is adhered to the support member 131, an adhesive such as, for example, epoxy may be used. However, an adhesive used to adhere the conductive member 133 to the support member 131 is not particularly to epoxy but may be any non-conductive adhesive.

The support member 131 may be made of non-woven or felt, similar to the above-mentioned sound absorbing material 125, but is not particularly limited thereto. For example, the support member 131 may be made of any non-conductive material as long as the above-mentioned lead wires may be easily inserted thereinto and fixed thereto.

According to the present embodiment, the support member 131 may have an area larger than that of an upper portion of the conductive member 133 but is particularly not limited thereto.

In addition, the support member 131 may have the same shape as that of the bottom surface 110a of an inner portion of the case 110 and the same area as that of the bottom surface 110a but is not particularly limited thereto.

However, the support member 131 may be manufactured to have a size at which it may contact the sidewall 110b of the case 110 when it is inserted into the inner portion of the case 110, in order to more easily assembly a product.

In addition, the entire thickness of the connection member 130 including the conductive member 133 and the support member 131 is preferably lower than a height of the sidewall 110b of the case 110.

The ultrasonic sensor 100 according to the present embodiment may include the temperature compensation element 140.

The temperature compensation element 140, which is a load capacity element having load capacity changed according to a temperature, serves to offset a resonant frequency of the piezoelectric element 120 through an increase in load capacity at the time of rise in a temperature.

In addition, the temperature compensation element 140 includes a first surface 140a having a positive (+) electrode formed thereon and a second surface 140b having a negative (−) electrode formed thereon, wherein the first and second surfaces 140a and 140b face each other as shown in FIG. 1.

According to the present embodiment, the temperature compensation element 140 is inserted into the connection member 130. More specifically, as shown in FIG. 1, the temperature compensation element 140 may be inserted into the connection member 130 so that the first surface 140a thereof contacts the first area A of the conductive member 133 and the second surface 140b thereof contacts the second area B of the conductive member 133.

Here, the conducive member 133 is provided with a cutting part (not shown) dividing the first and second areas A and B, and the support member 131 is provided with a groove (not shown) corresponding to the cutting part (not shown), such that the temperature compensation element 140 may penetrate through the cutting part (not shown) of the conductive member 133 and be then inserted into the groove (not shown) of the support member 131 by external force.

Here, the groove (not shown) may be only partially formed in the support member 131 in a thickness direction thereof or be formed to completely penetrate through the support member 131 in the thickness direction thereof. Therefore, the temperature compensation element 140 penetrating through the conductive member 133 may be mounted in the connection member 130 without penetrating though the support member 131 or be mounted therein so as to penetrate through the support member 131 to thereby be protruded to the outside as shown in FIG. 1.

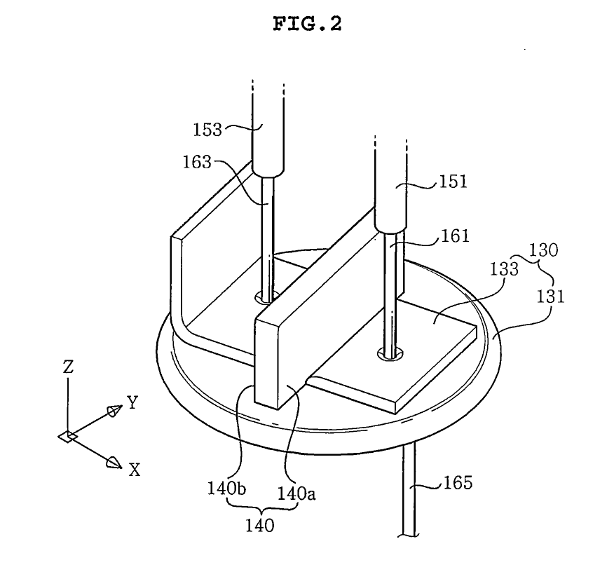

In addition, as shown in FIG. 2, the groove (not shown) formed in the support member 131 into which the temperature compensation element 140 is inserted preferably has a Y-direction length longer than that of the conductive member 133 adhered to an upper portion of the support member 131 and the support member 131 preferably has an area larger than that of the conductive member 133, but is not particularly limited thereto.

In addition, according to the present embodiment, it is preferable that the conductive member 133 is formed to have the Y-direction length smaller than that of the temperature compensation element 140 to thereby insert the temperature compensation element 140 into the connection member 130, such that the conductive member 133 is completely separated into two areas, for example, a positive (+) electrode part and a negative (−) electrode part by the temperature compensation element 140.

That is, the conductive member 133 is separated into the positive (+) electrode part and the negative (−) electrode part by the temperature compensation element 140. According to the present embodiment, all of the other end of the first lead wire 161 having one end connected to the first terminal 151, the other end of the second lead wire 163 having one end connected to the second terminal 153, and the other end of the third lead wire 165 having one end bonded to the piezoelectric element 120 may be inserted into the connection member 130.

That is, as shown in FIGS. 1 and 2, each of the other ends of the first and second lead wires 161 and 163 may be inserted in a direction from upper surfaces of the first and second areas A and B of the conductive member 133 toward lower surfaces thereof and be then inserted into the support member 131.

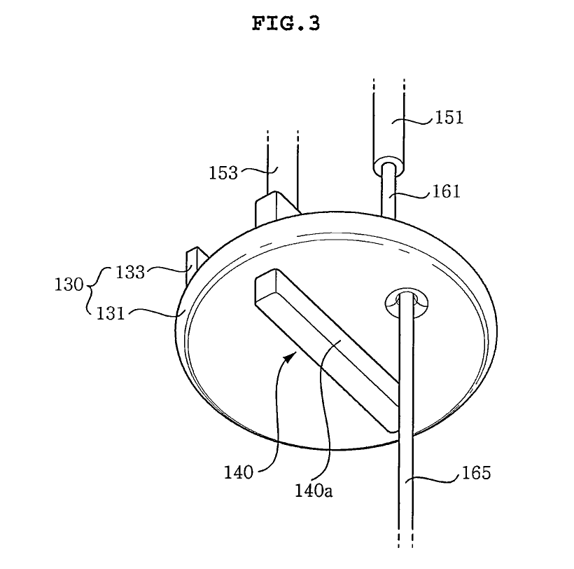

In addition, as shown in FIGS. 1 and 3, the other end of the third lead wire 165 may penetrate through the support member 131 from a lower portion of the support member 131 and be then inserted into the first area A of the conductive member 133.

Here, although FIGS. 1 to 3 show that each of the other ends of the first to third lead wires 161, 163, and 165 is inserted into the support member 131, the support member 131, and the conductive member 133 so as not to be protruded to outer portions thereof, the present invention is not particularly limited thereto. That is, each of the other ends of the first to third lead wires 161, 163, and 165 may also be inserted into the support member 131, the support member 131, and the conductive member 133 so as to be protruded to the outer portions thereof.

In addition, the conductive member 133 may include a groove (not shown), a cutting part (not shown), or the like, formed at portions thereof into which the first to third lead wires 161, 163, and 165 are inserted but is not limited thereto. For example, the first to third lead wires 161, 163, and 165 may also forcibly make a hole in the conductive member 133 and be then inserted thereinto by applying pressure thereto.

Further, in the ultrasonic sensor 100 according to the present embodiment, all of the above-mentioned components are inserted into the conductive member and connected to each other and a molding material is then filled in an empty space of the inner portion of the case 110, thereby making it possible to firmly fix loosely connected portions.

Here, as the molding material, epoxy molding compound (EMC), expandable polystyrene, silicon, or the like, may be used. However, the molding material is not particularly limited thereto.

As described above, the ultrasonic sensor 100 according to the present embodiment has a structure in which the temperature compensation element 140 is inserted into the connection member 130 including the conductive member 133 to thereby separate the conductive member 133 into the first area A, which is the positive (+) electrode part, and the second area B, which is the negative (−) electrode part, the first lead wire 161 connected to the first terminal 151 to which the positive (+) voltage is applied is inserted into the first area A, the second lead wire 163 connected to the second terminal 153 to which the negative (−) voltage is applied is inserted into the second area B, and the third lead wire 165 bonded to the piezoelectric element 120 is inserted into the first area A.

Therefore, in the ultrasonic sensor 100 according to the present embodiment, all the components, that is, the first terminal 151, the second terminal 153, the first lead wire 161, the second lead wire 163, the third lead wire 165, the piezoelectric element 120, the temperature compensation element 140, and the case may be electrically connected to each other without performing a soldering process.

In addition, as described above, since all the components are inserted into the conductive member and connected to each other, a manufacturing process of a product is simplified, thereby making it possible to perform mass production and automation without performing a soldering process.

According to the preferred embodiment of the present invention, the temperature compensation element penetrates through the conductive member to thereby separate the conductive member into two areas, and the lead wires to which each of the positive and negative voltages is applied and the lead wire bonded to the piezoelectric element are inserted into each area to be connected to each other, thereby making it possible to electrically connect each component of the ultrasonic sensor to each other without performing a soldering process.

In addition, according to the preferred embodiment of the present invention, since each component may be electrically connected to each other in a simple insertion scheme without performing a soldering process, a product is easily assembled, thereby making it possible to perform mass production and automation.

Although the preferred embodiments of the present invention have been disclosed for illustrative purposes, they are for specifically explaining the present invention and thus an ultrasonic sensor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. An ultrasonic sensor comprising:
a cylindrical case;
a piezoelectric element disposed on a bottom surface of an inner portion of the case;
first and second terminals to which each of positive and negative voltages is applied from the outside;
a connection member including a conductive member having a first area to which the first terminal is connected and a second area to which the second terminal is connected and a support member adhered to a lower surface of the conductive member; and
a temperature compensation element penetrating between the first and second areas of the conductive member and being then inserted into the support member.

2. The ultrasonic sensor as set forth in claim 1, wherein the conductive member is provided with a cutting part dividing the first and second areas,
the support member is provided with a groove corresponding to the cutting part, and
the temperature compensation element penetrates through the cutting part and is then inserted into the groove.

3. The ultrasonic sensor as set forth in claim 1, wherein the temperature compensation element penetrates through the conductive member so that each of a first surface having a positive electrode formed thereon and a second surface corresponding to the first surface and having a negative electrode formed thereon contacts the first and second areas.

4. The ultrasonic sensor as set forth in claim 1, further comprising:
a first lead wire having one end connected to the first terminal; and
a second lead wire having one end connected to the second terminal,
wherein each of the other ends of the first and second lead wires is inserted from upper surfaces of the first and second areas of the conductive member toward lower surfaces thereof and is then inserted into the support member.

5. The ultrasonic sensor as set forth in claim 1, further comprising a third lead wire having one end connected to an electrode formed on an upper portion of the piezoelectric element,
wherein the other end of the third lead wire penetrates through the support member and is then inserted from a lower surface of the first area of the conductive member toward an upper surface thereof.

6. The ultrasonic sensor as set forth in claim 1, wherein the second area of the conductive member has a ‘ [symbol] ’ bent shape, a ‘—’ portion of the ‘ [symbol] ’ shape being adhered to the support member and a ‘┐’ portion thereof contacting an inner sidewall of the case.

7. The ultrasonic sensor as set forth in claim 1, wherein the conductive member is made of a conductive rubber or a conductive film.

8. The ultrasonic sensor as set forth in claim 1, further comprising a sound absorbing material disposed on the piezoelectric element in the inner portion of the case.

9. The ultrasonic sensor as set forth in claim 1, further comprising a molding material filled in the inner portion of the case.

10. The ultrasonic sensor as set forth in claim 1, wherein the support member is made of a non-conductive material.

11. The ultrasonic sensor as set forth in claim 1, wherein the support member has the same shape as that of the bottom surface of the inner portion of the case.

12. The ultrasonic sensor as set forth in claim 1, wherein the support member has the same area as that of the bottom surface of the inner portion of the case.

13. The ultrasonic sensor as set forth in claim 1, wherein the entire thickness of the connection member is lower than a height of an inner wall of the case.
